(19) United States
(12) Patent Application Publication
(10) Pub. No.: US 2011/0170921 A1
(43) Pub. Date: Jul. 14, 2011

(54) DEVELOPING DEVICE, IMAGE FORMING APPARATUS, AND IMAGE FORMING METHOD

(75) Inventor: Takashi Ikeda, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/971,147

(22) Filed: Dec. 17, 2010

Related U.S. Application Data
(60) Provisional application No. 61/294,155, filed on Jan. 12, 2010.

(51) Int. Cl. G03G 15/00

(52) U.S. Cl. 399/388

(57) ABSTRACT

According to one embodiment, an image forming apparatus includes, in a recording medium contact region of a developing device housing, a first charging member charged to plus by friction. A transfer-roller-side conveyance guide opposed to the first charging member includes a second charging member and a third charging member in a recording medium contact region facing a recording medium conveying path.

### CROSS-REFERENCE TO RELATED APPLICATION

This application is based upon and claims the benefit of priority from the prior the U.S. Patent Application No. 61/294,155, filed on Jan. 12, 2010, and the entire contents of which are incorporated herein by reference.

### FIELD

Embodiments described herein relate generally to a developing device, an image forming apparatus, and an image forming method.

### BACKGROUND

An image forming apparatus such as a copy machine conveys a recording medium to a transfer device and transfers a developer image on an electrostatic latent image bearing member onto the recording medium by applying voltage to the developer image or pressing the developer image.

When the recording medium is conveyed, static electricity is generated in a region that comes into contact with the recording medium to cause friction. Paper powder is accumulated in the region by the static electricity. If the potential of the static electricity swings to plus, the paper powder is discharged from the region and an image stain occurs.

Concerning this point, there is proposed a technique for forming, with a conductor, a conveyance guide of a recording medium conveying path and grounding the conveyance guide to thereby discharge static electricity.

However, in a model in which a part of a developing device also serves as a recording medium conveying path and a recording medium being conveyed comes into contact with a part of the developing device, it is difficult to control static electricity generated in the developing device using the technique. This is because a magnetic body is stored on the inside of the developing device and stable supply of a developer is hindered when a housing of the developing device is formed of metal.

FIG. 5 is a diagram of voltage of a developing device in an image forming apparatus in the past. As shown in FIG. 5, both in a graph 502 indicating voltage in the case of ordinary temperature and ordinary humidity and a graph 501 indicating voltage in the case of low temperature and low humidity, the voltages are charged to the minus side as image formation is repeated. The graphs oscillate slightly because potential changes because of passage of a recording medium.

Paper powder is accumulated when the potential swings to the minus side. The paper powder is discharged from a recording medium conveyance guide of the developing device when the potential changes from the minus side to the plus side. In particular, the paper powder tends to accumulate in an opening section of a housing of the developing device.

The accumulated paper powder is attracted to the developing device housing charged to minus during image formation. However, the potential falls when the image formation is suspended for a while. When the image formation is resumed, the accumulated paper powder flies to the leading end of a recording medium charged to minus in a conveying process. Therefore, an image stain occurs.

FIG. 6 is an enlarged photograph of a recording medium on which an image is formed by the image forming apparatus in the past. As shown in a photograph 601 of FIG. 6, discharged paper powder adheres to the recording medium together with a developer and an image stain occurs.

### BRIEF DESCRIPTION OF THE DRAWINGS

FIG. 1 is a diagram of the configuration of an image forming apparatus;

FIG. 2 is an enlarged diagram of the vicinity of a developing device of the image forming apparatus;

FIG. 3 is a diagram of states of charging of a conveyance guide in the image forming apparatus and charging of a conveyance guide in the related art;

FIG. 4 is an enlarged photograph of a recording medium on which an image is formed by the image forming apparatus;

FIG. 5 is a diagram of the voltage of a developing device in an image forming apparatus in the past; and

FIG. 6 is an enlarged photograph of a recording medium on which an image is formed by the image forming apparatus in the past.

### DETAILED DESCRIPTION

Throughout this description, the embodiments and examples shown should be considered as exemplars, rather than limitations on the apparatus and methods of the present embodiments.

A developing device, an image forming apparatus, and an image forming method according to an embodiment are explained in detail below with reference to the accompanying drawings. The image forming apparatus is, for example, a copying machine, a MFP (Multifunction Peripheral), or a printer.

The developing device according to this embodiment includes: a mixer configured to agitate a developer; a developing roller including a magnetic body and configured to supply the developer to an electrostatic latent image bearing member; and a housing configured to house the mixer and the developing roller and including, at least in a section with which a recording medium being conveyed comes into contact, a first charging member charged to plus by friction.

The image forming apparatus according to this embodiment includes: an image forming unit configured to form a developer image on an electrostatic latent image bearing member; a transfer roller configured to transfer the formed developer image onto a recording medium; and a developing device including, in at least in a section of a housing with which the recording medium being conveyed comes into contact, a first charging member charged to plus by friction, the developing device being set upstream in a recording medium conveying direction of the transfer roller and configured to supply a developer to the electrostatic latent image bearing member of the image forming unit.

### Configuration of the Image Forming Apparatus

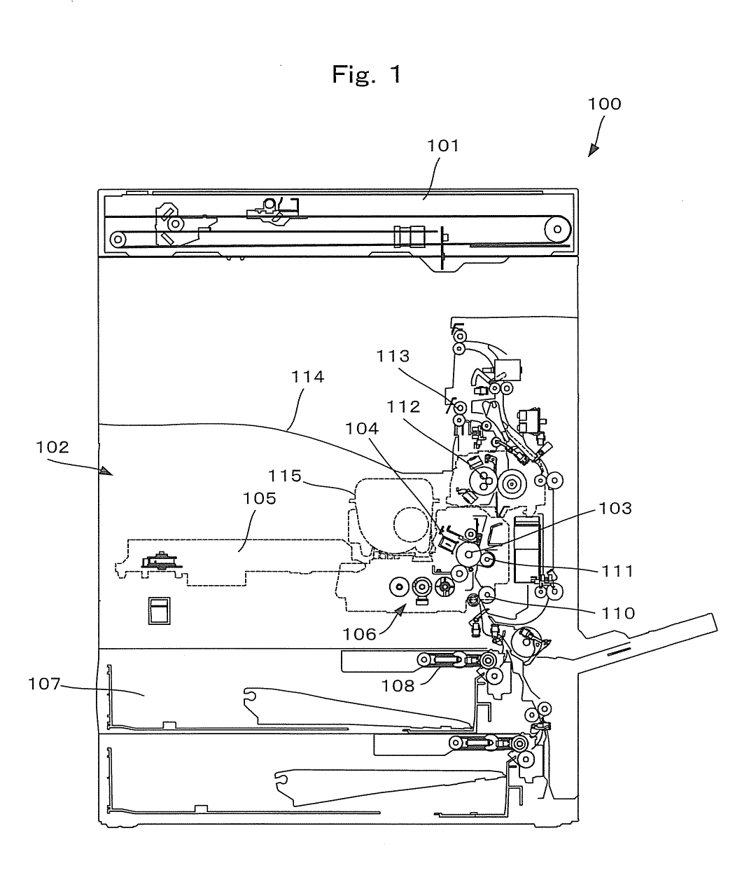

FIG. 1 is a diagram of the configuration of an image forming apparatus 100 according to this embodiment. As shown in FIG. 1, the image forming apparatus 100 includes an image reading unit 101 and an image forming unit 102.

The image reading unit 101 includes a carriage including an exposure lamp configured to expose an original document to light and a first reflection mirror, plural second reflection mirrors locked to a main body frame of the image forming apparatus 100, a lens block, and a CCD (Charge Coupled Device) of an image reading sensor.

The carriage stands still in a document reading section or reciprocatingly moves under a document table and reflects the light of the exposure lamp, which is reflected by the original document, to the first reflection mirror. The plural second reflection mirrors reflect the reflected light of the first reflection mirror to the lens block. The lens block outputs the reflected light to the CCD. The CCD converts the incident light into an electric signal and outputs the electric signal to the image forming unit 102 as an image signal.

The image forming unit 102 includes a photoconductive drum 103, which is an electrostatic latent image bearing member, a charging device 104, a laser irradiating unit 105, a developing device 106, and a developer supplying device 115.

The charging device 104 applies voltage to the photoconductive drum 103 and charges the photoconductive drum 103. The laser irradiating unit 105 irradiates a laser beam on the photoconductive drum 103 on the basis of the image signal and forms an electrostatic latent image on the photoconductive drum 103, which is the electrostatic latent image bearing member.

The developer supplying device 115 supplies a fresh developer to the developing device 106. The developing device 106 supplies the developer to the photoconductive drum 103 and forms a developer image from the electrostatic latent image.

A recording medium conveying mechanism includes, most upstream on a paper feeding unit 107 side, a pickup mechanism 108 configured to extract recording media one by one.

The pickup mechanism 108 extracts the recording media from the paper feeding unit 107 one by one and passes the recording medium to the recording medium conveying mechanism. The recording medium conveying mechanism conveys the recording medium to a transfer unit via an aligning roller 110.

A transfer roller 111 transfers the developer image on the photoconductive drum 103 onto the conveyed recording medium by applying voltage to or applying pressure to the developer image. A fixing roller 112 heats and presses the developer image and fixes the developer image on the recording medium.

The image forming apparatus 100 discharges the recording medium passed through the fixing roller 112 from a paper discharge port 113. The recording medium discharged from the paper discharge port 113 is stacked on a paper discharge tray 114.

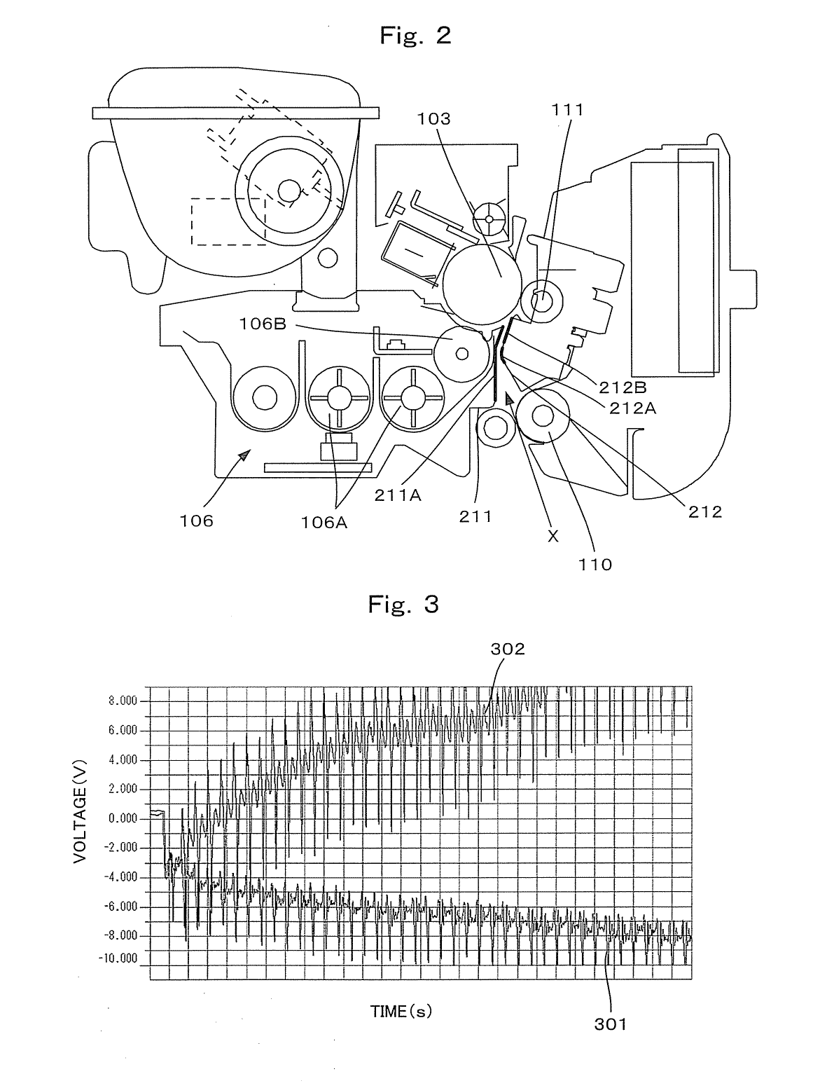

FIG. 2 is an enlarged diagram of the vicinity of the developing device 106 of the image forming apparatus 100. As shown in FIG. 2, the image forming apparatus 100 includes the developing device 106, a transfer-roller-side conveyance guide 212, the photoconductive drum 103, and the transfer roller 111 downstream in a recording medium conveying direction of the aligning roller 110, which is a conveying roller provided in a position immediately before the recording medium is conveyed to the transfer roller 111.

The developing device 106 includes a mixer 106A configured to agitate a developer applied with voltage and charged, a developing roller 106B including a magnetic body and configured to supply the developer to the photoconductive drum 103, and a developing device housing 211 configured to house the mixer 106A and the developing roller 106B.

The developing device 106 includes a first charging member 211A in a recording medium contact region of the developing device housing 211. The first charging member 211A is attached in the width direction of the developing device housing 211 at least by the width of a largest recording medium that can be processed by the image forming apparatus 100. The first charging member 211A is attached at least over an entire area of a section with which a recording medium being conveyed is likely to come into contact.

The developing device 106 includes, in a section of the developing device housing 211 also serving as a conveyance guide, a first charging member 211A charged to plus by friction.

The transfer-roller-side conveyance guide 212 opposed to the first charging member 211A includes a second charging member 212A and a third charging member 212B in a recording medium contact region facing the recording medium conveying path. The first charging member 211A forms the recording medium conveying path together with the second charging member 212A and the third charging member 212B.

The second charging member 212A and the third charging member 212B are attached at least over an entire area of the width of the largest recording medium that can be processed by the image forming apparatus 100. The second charging member 212A and the third charging member 212B are attached at least over an entire area of a section with which a recording medium being conveyed is likely to come into contact.

The third charging member 212B is attached further downstream in the recording medium conveying direction than the second charging member 212A. A gap may be provided between the second charging member 212A and the third charging member 212B, because a charging member to be used can be saved if the gap is provided.

The second charging member 212A and the third charging member 212B may be integrally formed.

The image forming apparatus 100 includes the first charging member 211A, the second charging member 212A, and the third charging member 212B downstream in the recording medium conveying direction of the aligning roller 110 and upstream in the recording medium conveying direction of the transfer roller 111.

The image forming apparatus 100 includes the first charging member 211A, the second charging member 212A and the third charging member 212B such that a recording medium does not come into contact with a conveyance guide of the recording medium conveying path from the aligning roller 110 to the transfer roller 111.

The image forming apparatus 100 includes all of the first charging member 211A, the second charging member 212A, and the third charging member 212B further upstream in the recording medium conveying direction than the transfer roller 111 in order to prevent paper powder from being fixed on a recording medium together with a developer.

The first charging member 211A, the second charging member 212A, and the third charging member 212B are formed of a material charged to plus by friction. As the material charged to plus by friction, for example, polycarbonate can be used. In this embodiment, SUNROID ECO SHEET (Japanese registered trademark) polycarbonate manufactured by Sumitomo Bakelite Co., Ltd. is used.

The first charging member 211A, the second charging member 212A, and the third charging member 212B can be formed by bonding polycarbonate sheets with adhesive.

The developing device housing 211 or the transfer-roller-side conveyance guide 212 itself can also be formed by the material charged to plus by friction.

When image formation is started, the image forming apparatus 100 conveys a recording medium in a direction of an arrow X with the aligning roller 110. The recording medium comes into contact with only the first charging member 211A, the second charging member 212A, and the third charging member 212B and enters a nip portion between the photoconductive drum 103 and the transfer roller 111.

The first charging member 211A, the second charging member 212A, and the third charging member 212B are charged to plus by friction and are not charged to minus. Therefore, the first charging member 211A, the second charging member 212A, and the third charging member 212B do not accumulate paper powder.

On the other hand, the recording medium does not come into contact with the conveyance guide of the recording medium conveying path from the aligning roller 110, which is the conveying roller provided in the position immediately before the recording medium conveying direction of the transfer roller 111, to the transfer roller 111. Since the recording medium does not come into contact with the conveyance guide, the conveyance guide is not charged to minus. Therefore, the conveyance guide does not accumulate paper powder.

FIG. 3 is a diagram of states of charging of the conveyance guide in the image forming apparatus 100 according to this embodiment and the conveyance guide of the technique in the past. A graph 301 is a graph indicating a state of charging of the conveyance guide in the past. A graph 302 is a graph indicating a state of charging of the conveyance guide according to this embodiment.

As indicated by the graph 301 shown in FIG. 3, when image formation is performed, the conveyance guide in the past is charged to minus. On the other hand, as indicated by the graph 302, the conveyance guide in the image forming apparatus 100 according to this embodiment is charged to the plus side because the conveyance guide includes the first charging member 211A, the second charging member 212A, and the third charging member 212B.

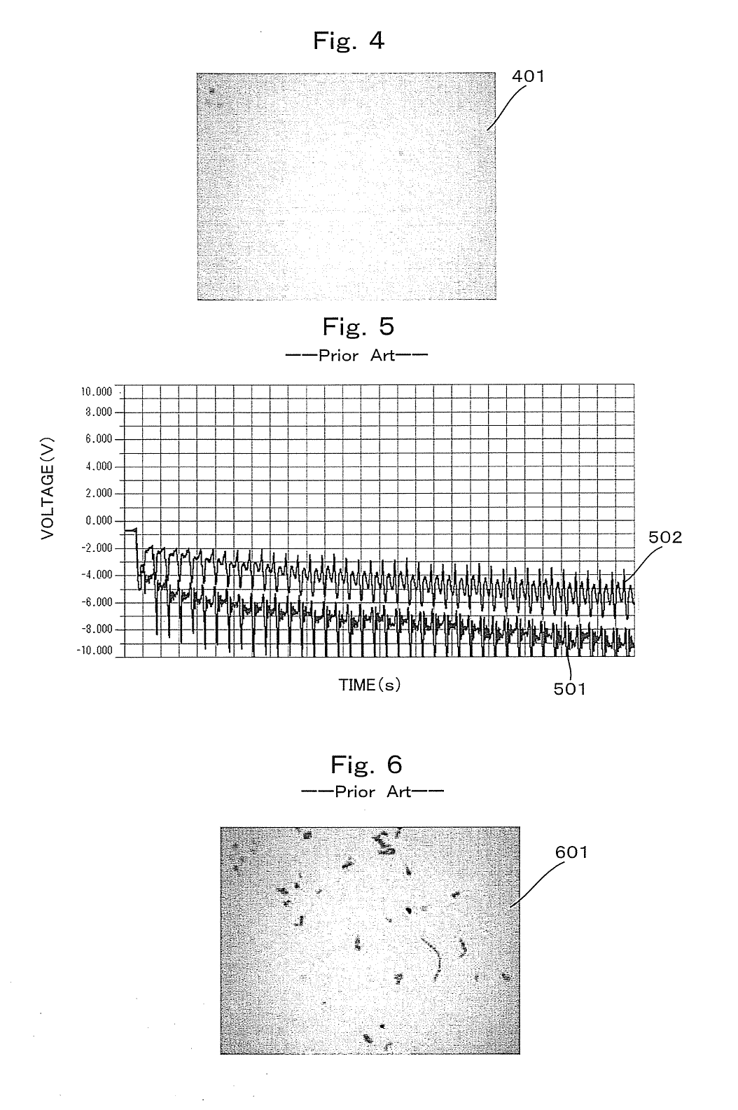

FIG. 4 is an enlarged photograph of a recording medium on which an image is formed by the image forming apparatus 100 according to this embodiment. As shown in a photograph 401 in FIG. 4, since discharged paper powder does not adhere to a recording medium together with a developer, an image stain does not occur.

As explained above, the image forming apparatus 100 according to this embodiment includes, in the recording medium contact region of the developing device housing 211, the first charging member 211A charged to plus by friction. The transfer-roller-side conveyance guide 212 opposed to the first charging member 211A includes the second charging member 212A and the third charging member 212B in the recording medium contact region facing the recording medium conveying path.

Therefore, there is an effect that the recording medium conveying path is not charged to minus by conveyance of the recording medium and does not accumulate paper powder and an image stain less easily occurs.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. A developing device comprising:
a mixer configured to agitate a developer;
a developing roller including a magnetic body and configured to supply the developer to an electrostatic latent image bearing member; and
a housing configured to house the mixer and the developing roller and including, at least in a section with which a recording medium being conveyed comes into contact, a first charging member charged to plus by friction.

2. The device according to claim 1, wherein the first charging member is attached in a width direction of the housing at least by width of a largest recording medium that can be processed by an image forming apparatus.

3. The device according to claim 1, wherein the first charging member is attached at least over an entire area of a section with which a recording medium being conveyed is likely to come into contact.

4. The device according to claim 1, wherein the first charging member is attached to a section of the housing also serving as a conveyance guide.

5. The device according to claim 1, wherein the first charging member is attached downstream in a recording medium conveying direction of a conveying roller provided in a position immediately before the recording medium is conveyed to a transfer roller and upstream in the recording medium conveying direction of the transfer roller.

6. The device according to claim 1, wherein the first charging member forms a recording medium conveying path together with a second charging member set in a conveyance guide on a transfer roller side.

7. The device according to claim 1, wherein the first charging member is formed of polycarbonate.

8. An image forming apparatus comprising:
an image forming unit configured to form a developer image on an electrostatic latent image bearing member;
a transfer roller configured to transfer the formed developer image onto a recording medium; and
a developing device including, in at least in a section of a housing with which the recording medium being conveyed comes into contact, a first charging member charged to plus by friction, the developing device being set upstream in a recording medium conveying direction of the transfer roller and configured to supply a developer to the electrostatic latent image bearing member of the image forming unit.

9. The apparatus according to claim 8, wherein the first charging member is attached in a width direction of the housing at least by width of a largest recording medium that can be processed by an image forming apparatus.

10. The apparatus according to claim 8, wherein the first charging member is attached at least over an entire area of a section with which a recording medium being conveyed is likely to come into contact.

11. The apparatus according to claim 8, wherein the first charging member is attached to a section of the housing also serving as a conveyance guide.

12. The apparatus according to claim 8, wherein the first charging member is attached downstream in a recording medium conveying direction of a conveying roller provided in a position immediately before the recording medium is conveyed to the transfer roller and upstream in the recording medium conveying direction of the transfer roller.

13. The apparatus according to claim 8, further comprising a second charging member in a transfer-roller-side conveyance guide upstream in the recording medium conveying direction of the transfer roller, wherein
the first charging member forms a recording medium conveying path together with the second charging member.

14. The apparatus according to claim 8, wherein the transfer-roller-side conveyance guide includes a third charging member downstream in the recording medium conveying direction of the second charging member with a gap provided between the second charging member and the third charging member.

15. The apparatus according to claim 8, wherein the first charging member is formed of polycarbonate.

16. An image forming method for an image forming apparatus comprising:
bringing a recording medium into contact with a first charging member set at least in a section of a housing of a developing device with which the recording medium being conveyed comes into contact and charged to plus by friction and conveying the recording medium to a transfer roller; and
transferring a developer image on an electrostatic latent image bearing member onto the recording medium.

17. The method according to claim 16, further comprising bringing the recording medium into contact with the first charging member attached in a width direction of the housing at least by width of a largest recording medium that can be processed by the image forming apparatus and conveying the recording medium to the transfer roller.

18. The method according to claim 16, further comprising bringing the recording medium into contact with the first charging member attached in an entire area of a section with which the recording medium being conveyed is likely to come into contact and conveying the recording medium to the transfer roller.

19. The method according to claim 16, further comprising bringing the recording medium into contact with the first charging member attached at least over an entire area of a section with which the recording medium being conveyed is likely to come into contact and conveying the recording medium to the transfer roller.

20. The method according to claim 16, further comprising bringing the recording medium into contact with the first charging member and a second charging member provided in a transfer-roller-side conveyance guide upstream in a recording medium conveying direction of the transfer roller and conveying the recording medium to the transfer roller.
